(19) United States
(12) Patent Application Publication
(10) Pub. No.: US 2020/0225648 A1
(43) Pub. Date: Jul. 16, 2020

(54) Automated Assignment of Measurement Data for Cloud-Based Monitoring of Mechanical Assets

(71) Applicant: SIEMENS AKTIENGESELLSCHAFT, Muenchen (DE)

(72) Inventors: Bernd-Markus PFEIFFER, Uttenreuth (DE); Douglas WEBER, Karlsruhe (DE); Daniel LABISCH, Karlsruhe (DE)

(73) Assignee: SIEMENS AKTIENGESELLSCHAFT, Muenchen (DE)

(21) Appl. No.: 16/647,904

(22) PCT Filed: Aug. 22, 2018
(86) PCT No.: PCT/EP2018/072647

§ 371 Date: Mar. 17, 2020

(30) Foreign Application Priority Data
Sep. 29, 2017 (EP) 17194030.7

(51) Int. Cl. G05B 19/418; G06K 9/62; G06N 20/00

(52) U.S. Cl. CPC G05B 19/41865; G05B 19/4183; G06N 20/00; G06K 9/6256; G05B 19/4188

(57) ABSTRACT

A method for assigning measurement data for cloud-based monitoring of mechanical assets of an industrial facility that includes a measurement data archive, in which measurement data from a multiplicity of measurement points are stored, includes establishing an asset that has a particular type, the asset being assigned a characteristic measurement value with an associated measurement point in the cloud; reading a connection, stored in the cloud for the particular asset type, between measurement values, relevant to the particular asset type, from various measurement points; gradually estimating parameters of the connection, using the characteristic measurement value belonging to the particular asset type and the measurement data of the measurement values relevant to the particular asset; gradually comparing the previously determined connection with the measurement data used for the estimation and determining a residual; and assigning the measurement data to a particular asset based on a statistical evaluation of the determined residual.

### CROSS-REFERENCE TO RELATED APPLICATIONS

This is a U.S. national stage of application No. PCT/EP2018/072647 filed Aug. 22, 2028. Priority is claimed on EP Application No. EP17194030 filed Sep. 29, 2017, the content of which is incorporated herein by reference in its entirety.

### BACKGROUND OF THE INVENTION

### 1. Field of the Invention

The invention relates to a computer system and to a method for assigning measurement data for cloud-based monitoring of mechanical assets of an industrial facility, in particular a manufacturing or production plant, where the industrial facility has a measurement data archive in which measurement data obtained from a multiplicity of measurement points, in particular pressure or flow sensors, is stored. A computer program having computer-executable program code instructions, a storage medium.

### 2. Description of the Related Art

Condition monitoring of mechanical assets of an industrial facility, such as pumps, valves or heat exchangers, can increase the downtime resilience and productivity of an industrial facility. One aim of the monitoring in this case is to detect wear and tear processes or unfavorable operating conditions at an early stage. Among other things, this enables effects of signs of wear and tear to be determined and risks of failure or remaining service lifetimes to be estimated. This permits a targeted planning of maintenance activities.

Measurement data of the corresponding assets obtained at different measurement points constitutes a basis for the monitoring. In the case of a valve as asset, for example, a flow rate, a pressure upstream and downstream of the valve and a valve position are routinely available as measurement data.

In the course of an automated, cloud-based monitoring of mechanical assets, it is necessary to compile relevant measurement data for each asset, such as a flow rate or a pressure upstream or downstream of the asset, and to transfer the data to the cloud. The data obtained from the corresponding measurement points of a multiplicity of assets can then be evaluated in the cloud.

A cloud-based monitoring system has the important advantage that automated monitoring of a multiplicity of mechanical assets can be realized with a relatively small amount of engineering overhead. A prerequisite for this is that the measurement points required for the monitoring are available and are assigned to the respective asset. Manually looking up and assigning the relevant measurement data for the respective asset, as performed previously in the prior art, requires not only access to corresponding documentation of the industrial facility and a precise knowledge of the workflow processes of the industrial facility, but also a disproportionately high investment in terms of time and human resources.

Asset monitoring is currently performed, for example, with the aid of Siemens AG's SIMATIC® PCS 7 engineering system. In the Condition Monitoring Library implemented therein, function blocks possessing a corresponding monitoring functionality are provided. In this system, each function block can monitor precisely one asset. In order to assign individual measurement data to a function block, the data must be manually linked to the respective function block in a Continuous Function Chart (CFC) editor of the SIMATIC® PCS 7 system.

In the case of a pump or a valve as asset, the manual assignment of the measurement points to the respective asset has hitherto been performed based on a diagram known as a Piping and Instrumentation Diagram (P&ID). Starting from an asset under consideration, it is determined based on the P&ID diagram whether measurement points for pressure and flow are present in the same pipeline as the asset. Here, the search range in the pipeline is limited by branches or flow resistances because it may be assumed that uninfluenced pressure or flow conditions are present only in a section of pipeline that has no branches or significant flow resistances.

If the pipeline under consideration leads out from a container, then the pressure value to be assigned to the corresponding asset can often be derived from the pressure in the container or from its fill level. If, in the reverse case, the pipeline leads into a container, then it is necessary to check at which point of the container this happens. With an open inlet, it may be that only the geodetic height of the inlet connector of the container is significant and the pressure per se stays constant.

Ideally, the P&ID diagram is available in an electronic, machine-readable and object-oriented form so that the relevant measurement points can be found automatically and assigned to corresponding assets. However, it should not be assumed that such a P&ID diagram will be available for every cloud-based application in the foreseeable future.

There are already conventional methods based, for example, on Siemens AG's Control Performance Analytics platform which, in the course of a cloud-based control loop feedback analysis, identify all function blocks of a type “PID controller” in a process control system of an industrial facility and in each case export all associated controlling variables, controlled variables and setpoints of the controllers in particular to the cloud. As a result, all measurement data relevant to the assessment of the controller behavior can be determined and selected automatically. This procedure can be applied analogously to valve or pump blocks, which then directly return the valve position or the pump speed, as the case may be.

In order to assess a valve asset, for example, the data (the valve position in this instance) obtained from the above-described analysis of the valve blocks is not sufficient. Additional measurement data is also required from measurement points that are not coupled to the respective block and therefore cannot be ascertained automatically via the known methods. Referring to the example of the valve, measurement data on the flow rate through the valve and pressure values upstream and downstream of the valve is required in addition. Analogous considerations apply, for example, to a pump, where only a speed of the pump is assigned to the associated block. The measurement data for the flow rate as well as for the two pressure values must likewise be ascertained separately (manually).

The measurement data that is not assigned to any block has hitherto been compiled and assigned manually, which is a very laborious and time-consuming process and significantly compromises the functionality of a cloud-based monitoring of mechanical assets of an industrial facility.

### SUMMARY OF THE INVENTION

It is an object of the invention to provide a method for assigning measurement data for cloud-based monitoring of mechanical assets that runs as a fully automated process and significantly reduces the overhead required for the assignment and, concomitant therewith, for the monitoring in comparison to previously known conventional methods.

This and other objects and advantages are achieved in accordance with the invention by a computer program having computer-executable program code instructions, a storage medium, a computer system and a method for assigning measurement data for cloud-based monitoring in particular of mechanical assets of an industrial facility.

In an assignment method of the type cited in the introduction, the object is achieved according to the invention by a) transferring a subset or a total set of the measurement data from the measurement data archive to the cloud to enable a further processing of the measurement data in the cloud; b) establishing an asset that has a particular type, in particular a valve or a pump, where the asset is assigned a characteristic measurement value with an associated measurement point in the cloud; c) reading out a general physical relationship, stored in the cloud for the particular asset type, between measurement values, relevant to the particular asset type, obtained from different measurement points; d) estimating the parameters of the physical relationship step by step using the characteristic measurement value belonging to the particular asset type and the measurement data, stored in the measurement data archive, of the measurement values relevant to the particular asset; e) comparing the previously determined physical relationship step by step with the measurement data used for the estimation and determining a residual; and f) assigning the measurement data to a particular asset based on a statistical evaluation of the determined residual.

What is understood in the present context by the concept of the cloud or, to put it another way, by a cloud computing system, is a server infrastructure of an external cloud provider (external cloud) or local server hardware within the industrial facility (local cloud).

A prerequisite for the above-explained method in accordance with the invention is that all relevant measurement data can be accessed at one point for the purpose of the assignment. It is immaterial in this regard whether the data is initially stored in the measurement data archive of the industrial facility and then transferred (block by block, if necessary) to the cloud or whether the data is transferred cyclically to the cloud directly and stored only there.

First, either all the measurement data or at least a subset of the measurement data are transferred from the measurement data archive to the cloud in order to permit fast and location-independent access to the data, and in order, if necessary, to enable the higher computing capacities of a cloud computing system to be exploited.

In the following method step, an asset of a particular type is specified, for example a valve or a pump. Every asset in an industrial facility is normally assigned at least one characteristic measurement value. In the case of a valve asset, this is usually the valve position. In the case of a pump, it may be, for example, the electrical driving power or the speed.

A general physical relationship between relevant measurement values of different measurement points is known and stored in the cloud for each asset contained in an industrial facility. For a valve asset, for example, there exists a physical relationship between a flow rate through the valve, the valve position already mentioned earlier, and a pressure difference upstream and downstream of the valve. This general physical relationship, in other words a physical equation, is read out from the cloud and used as a reference for the further assignment method.

The physical relationship is henceforth referred to in the following only as an equation. In its general form, the equation has unknown parameters that are estimated in the next step of the method in accordance with the invention. The characteristic measurement value belonging to the particular asset type is included here in the estimation, i.e., the valve position in the case of the valve asset.

Next, using known estimation methods such as the least squares method, the unknown parameters are estimated step-by-step from the measurement data stored in the measurement data archive that is relevant in each case to the particular asset, i.e., which can be assigned to the asset.

If the least squares method is used, the equation is brought into the implicit form 0=F(x,p), where x denotes all the variables, p the parameters to be estimated, and F a function. For the measurement data of a measurement value, the residual

R=sum_t(F(X(t),p))\hat{ }2 (1)

can be calculated in each case by a stepwise insertion of measurement data X(t), where sum_t stands for a temporal summation function. For small values of the residual, the measurement data behaves in accordance with the physical relationship on which the equation is based. For large residuals, it should be assumed that the measurement data does not behave in accordance with the physical relationship, i.e., does not belong to the searched-for asset.

For further information on the estimation method, reference is made to the publication titled “Zustandsüberwachung mechanischer Komponenten mit Hilfe physikalischer Modelle and niedrigdimensionaler Kennfelder” (“Condition monitoring of mechanical components with the aid of physical models and low-dimensional characteristic maps”), published on Jul. 13, 2017 by Prior Art Publishing GmbH, register number 1136893830 in the catalog of the German National Library, the contents of which are hereby incorporated by reference herein in their entirety.

The estimation method for determining the unknown parameters of the equation is performed step-by-step with all the relevant measurement data stored in the measurement data archive. In the process, the residual of the measurement data of a measurement value is determined in each case and, as explained previously, statistically evaluated. The estimation can in this case be performed sequentially for the respective measurement data from a measurement point or, given a correspondingly present calculation architecture, also in parallel.

The assignment method in accordance with the invention is based in this case on the knowledge that measurement data obtained from a particular measurement point leads to a slight deviation, i.e., a small residual, when it has a connection to the respective measurement point or the in particular mechanical asset, in other words when it concerns the searched-for measurement value. Otherwise, the physical equation cannot plausibly describe the behavior revealed in the measurement data, with the result that major deviations exist between the measurement data and the parameterized physical equation or a large residual occurs.

It is therefore possible within the scope of the present invention to assign to the asset particular measurement data from a measurement point in respect of which the equation obtained from the respective measurement data has the smallest residual. The least squares method is an example of a suitable approach for determining the residual, as indicated in equation (1). However, other known statistical evaluation methods are also applicable within the scope of the invention in order to conduct a statistical evaluation of the determined deviations and enable an assignment of the measurement points or the associated measurement data to be performed.

It falls within the scope of the invention to perform the inventive method step-by-step in an automated manner for a multiplicity of assets in order to enable a comprehensive assignment of the measurement data to be performed within the industrial facility. In this case, the method in accordance with the invention permits, for the first time, an automated assignment of relevant measurement data or measurement points within an industrial facility to particular assets, in particular mechanical, electromechanical or electrical assets, in order to enable effective and resource-saving monitoring of the assets to be performed.

In a particularly advantageous embodiment of the method in accordance with the invention, the volume that is to be considered out of the measurement data transferred to the cloud in order to perform the estimations is reduced by taking only measurement data having a particular physical unit into consideration. If, for example, an initial search for a pressure sensor of a valve is conducted, then only measurement data to which a unit of pressure, for example bar, is assigned is taken into account for the further evaluation. The volume of data to be examined can be significantly reduced by this measure, as a result of which the method overall can be performed faster.

As part of a subsequent plausibility check on the previously filtered measurement data, the measurement data is advantageously checked to determine whether it is in any way relevant to a specific type of measurement point. In particular a temporal dependence of the measurement data is considered in this case. However, statistical values such as means, medians, variances, offsets and the like may also be used within the scope of the plausibility check.

If, for example, a search is performed for data from pressure sensors in the vicinity of a valve, a behavior of the measurement data with respect to time may be instructive. If the measurement data obtained from a particular measurement point is constant over a period of time in which there are changes in a position of the valve and a flow through the valve, then the examined measurement data cannot relate to a valve output pressure.

The measurement data that is deemed implausible from particular measurement points is then no longer taken into account for the further evaluation.

It lies within the scope of the invention, within the scope of the above-explained advantageous embodiments of the inventive method, to proceed as follows: The measurement data is stored in the measurement data archive of the industrial facility and transferred either completely or cyclically to an internal cloud. After the above-explained preselection methods have been performed on site, in other words in the (internal) cloud established in the form of local server hardware within the industrial facility, only the measurement data deemed relevant to the asset monitoring is subsequently transferred to the (external) cloud.

In an assignment method of the type described in the introduction, the object is also achieved according to the invention by
a) transferring a subset or a total set of the measurement data from the measurement data archive to the cloud in order to enable a further processing of the measurement data in the cloud; b) identifying controller blocks that are part of the industrial facility; c) comparing all the manipulated variables of the controller blocks with setpoints stored in the measurement data archive and/or the cloud for in particular mechanical assets; d) acquiring a controlled variable of the respective controller block and determining a physical unit and a designation for the associated measurement point of the controlled variable; and e) identifying a type of the respective controller block based on the controlled variable as well as its physical unit and measurement point designation.

First, all controller blocks that are part of the industrial facility are searched for and identified in the industrial facility. A controller block may be a PID controller, for example.

In the subsequent comparison, if there is found at a controller block, for example, a manipulated variable profile that exactly matches a position profile stored in the measurement data archive or the cloud in relation to a valve under consideration, then the controller block is the process controller actuating the valve.

The following determination of the physical unit of the respective measurement data and the designation of the associated measurement point reveals to which controller type the previously found controller block belongs. If the physical unit is, for example, “mass or volume per unit time” and the designation is “flow”, then the controller type is a flow controller that regulates the flow through the valve.

If the physical unit is a pressure value, then the controller type can be a pressure controller for regulating the pressure upstream or downstream of the valve. In this case, the following consideration can be applied: If the pressure in a pipeline is being controlled, the pressure downstream of the valve is regulated in most cases. This pressure reacts very quickly to valve movements, which is reflected in the variation with time of the associated measurement data. If the pressure in a container is being controlled via an outlet valve, on the other hand, the pressure is normally regulated upstream of the valve. Here, the pressure typically reacts more slowly to the valve movements due to the buffering capacity of the container. The measurement data can easily and automatically be assigned to a particular controller of a particular asset on the basis of these boundary conditions.

The controlled variable determined with the aid of the above-explained method, which variable represents a measurement value relevant to the asset, is attended by the advantage that one unknown variable fewer has to be found for subsequent data processing methods.

In an assignment method of the type described in the introduction, the object is achieved in accordance with the invention by
a) transferring a subset or a total set of the measurement data from the measurement data archive to the cloud in order to enable a further processing of the measurement data in the cloud; b) establishing an asset that has a particular type, in particular a valve or a pump, where the asset is assigned a characteristic measurement value with an associated measurement point in the cloud; c) identifying controller blocks that are part of the industrial facility; d) comparing all the manipulated variables of the controller blocks with setpoints stored in the measurement data archive and/or the cloud for in particular mechanical assets; e) acquiring a controlled variable of the respective controller block and determining a physical unit and a designation for the associated measurement point of the controlled variable; f) identifying a type of the respective controller block on the basis of the controlled variable as well as its physical unit and measurement point designation; g) reading out a general physical relationship, stored in the cloud for the particular asset type, between measurement values, relevant to the particular asset type, obtained from different measurement points; h) estimating parameters relating to the physical relationship using the characteristic measurement value belonging to the particular asset type, the controlled variable belonging to the controller block, and historical measurement data stored in the cloud; i) comparing the measurement data stored in the measurement data archive step by step with the previously determined physical relationship and determining a deviation; and j) assigning the measurement data to a particular asset on the basis of a statistical evaluation of the determined deviations.

As a result of the previously performed identification of the controller blocks belonging to the particular asset and of the associated controlled variable, there is one variable fewer requiring to be determined by means of residual calculations. In the case of a valve asset, the variables “valve position”, “flow rate” and “pressure difference” are part of the equation. Here, the variable “pressure difference” can be calculated from the two variables “pressure upstream of the valve” and “pressure downstream of the valve”.

In the first method step in accordance with the invention, the first variable “valve position” is obtained through the choice of the particular asset (in this case: valve asset). The second variable “flow rate” is determined based on the identification of the controller blocks. Thus, the equation to be estimated now has only two further unassigned variables, which can make performing the estimation significantly easier and improve the quality of the results of the estimation and the quality of the assignment.

In a particularly advantageous embodiment of the above-explained method in accordance with the invention, out of the measurement data transferred to the cloud, the volume of measurement data that is to be considered for performing the estimations is reduced by considering only measurement data that has a particular physical unit. If, for example, a search is to be initially performed for a pressure sensor of a valve, then only measurement data to which a unit of pressure, such as bar, is assigned is taken into account for the further evaluation. The volume of data to be examined can be significantly reduced by this measure, as a result of which the method overall can be performed faster.

As part of a subsequent plausibility check of the previously filtered measurement data, the measurement data is advantageously checked to determine whether it is in any way relevant to a specific type of measurement point. In particular, a temporal dependence of the measurement data is considered in this case. However, statistical values such as means, medians, variances, offsets and the like may also be used within the scope of the plausibility check.

If, for example, a search is performed for data of pressure sensors in the vicinity of a valve, a behavior of the measurement data with respect to time may be instructive. If the measurement data of a particular measurement point is constant over a period of time in which there are changes in a position of the valve and a flow through the valve, then the examined measurement data cannot relate to a valve output pressure.

The measurement data deemed implausible that has been obtained from particular measurement points is then no longer taken into account for the further evaluation.

In an advantageous embodiment of the method in accordance with the invention, only a subsection of the industrial facility, preferably only a particular process engineering unit (e.g., fractionating column, continuous-flow stirred-tank reactor, fermenter), is taken into account for identifying the measurement data having the particular physical unit. The limitation significantly constrains the measurement data or measurement points relevant to a respective asset, which can increase the assignment accuracy and reduce the overhead required for the assignment method.

Advantageously, the measurement data is subdivided into training data and validation data prior to commencement of the assignment method, thereby enabling the assignment method to be improved further. If measurement data from a measurement point that does not belong to a particular asset is used for parameterizing the physical equation, then the deviation of the validation data turns out even higher than without a subdivision of the measurement data. This enables the measurement data to be assigned even more accurately to a particular asset.

Within the scope of a particularly advantageous embodiment of the assignment method, following completion of the assignment method, a user of the industrial facility is automatically presented with suggestions relating to an assignment of individual measurement data to particular assets. Here, the user is not required to work through any long signal lists but is presented with a single assignment as the result of the automated assignment process. As a consequence, it can be ensured with a reasonable amount of additional overhead that no asset monitoring system is put into operation which makes incorrect assignments of measurement points to assets.

Particularly when the assignment cannot be made with a sufficiently high degree of certainty in borderline cases, it is furthermore advantageous if, following completion of the assignment method, the user is automatically presented with a multiplicity of suggestions, whereupon the user can make a manual decision about a definitive assignment of the measurement data to particular assets. Possible misassignments can be effectively avoided by this means.

The described method together with its embodiments is preferably implemented in software. The above-stated objects are accordingly achieved also via a computer program having computer-executable program code instructions for implementing the inventive embodiments of the method. The computer may be an automation device having a processing unit in the manner of a processor or the like.

An automation device, in particular an industrial automation device, on which a computer program of the aforesaid type is implemented is an example of a computer system to which the invention likewise relates. Instead of the automation device, standard computers, such as are typical in office automation, are also eligible for consideration.

The computer program for implementing the method is usually held available on or in a storage medium, i.e., for example, on a magnetic or optical data medium or in a semiconductor memory, so that the invention also relates to a storage medium having a computer-executable computer program for implementing the inventive method and its embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention, as well as the manner in which these are realized, will become clearer and more readily understandable in connection with the following description of the exemplary embodiment, which is explained in more detail with reference to the two drawings, in which:

FIG. 1 shows a graphical plot of a characteristic map of a valve asset with measurement data belonging to the valve asset;

FIG. 2 shows a graphical plot of the characteristic map of the valve asset with measurement data not belonging to the valve asset;

FIG. 3 is a flowchart of the method in accordance with the invention;

FIG. 4 is a flowchart of the method in accordance with an embodiment of the invention; and

FIG. 5 is a flowchart of the method in accordance with an alternative embodiment of the invention.

### DETAILED DESCRIPTION OF THE EXEMPLARY EMBODIMENTS

A method in the invention is explained taking the example of a valve asset. It should be understood that the method can also be applied to other mechanical, electromechanical or electrical assets.

Firstly, either all the measurement data or at least a subset of the measurement data are transferred from the measurement data archive to the cloud in order to enable fast and location-independent access to the data. Here, the cloud may be an internal cloud or an external cloud (outside of the industrial facility).

In the following method step, all assets of the type “valve” and all controller blocks are searched for and identified in the industrial facility. Here, the controller blocks are PID controllers. It can be assumed here that corresponding controller blocks also exist for the majority of the valve assets contained in the industrial facility.

In a subsequent comparison, the data of all the manipulated variables of the controller blocks is compared with the setpoint valve positions of the valve blocks. The setpoint valve positions are in this case stored in the industrial facility, such as in the measurement data archive, or in the cloud itself. If, during the comparison, there is found at a controller block a manipulated variable profile that exactly matches a setpoint value profile stored in the measurement data archive or the cloud in relation to a valve under consideration, then the controller block is the process controller actuating the valve.

A following determination of the physical unit of the respective measurement data and the designation of the associated measurement point reveals to which controller type the previously found controller block belongs. If the physical unit is, for example, “mass or volume per unit time” and the designation is “flow”, then the controller type is a flow controller for regulating the flow through the valve.

If the physical unit is a pressure value, then it can be a pressure controller upstream or downstream of the valve. Here, the following consideration can be applied: If a pressure in a pipeline is being controlled, the pressure downstream of the valve is regulated in most cases. This pressure reacts very quickly to valve movements, which is reflected in the variation with time of the associated measurement data. If, on the other hand, a pressure in a container is being controlled by means of an outlet valve, then the pressure is normally regulated upstream of the valve. In this case, the pressure typically reacts more slowly to the valve movements due to the buffering capacity of the container. The measurement data can easily and automatically be assigned to a particular controller of a particular asset based on these boundary conditions.

In the present exemplary embodiment, a flow controller has been found for the valve, which means that two more pressure values (upstream and downstream of the valve) still need to be found in order to enable a complete mapping of the valve behavior.

In a next method step, the volume of measurement data transferred to the cloud is reduced by considering only measurement data having a particular physical unit. Here, a search is conducted for pressure sensors of the valve. Therefore, only measurement data to which a unit of pressure, such as bar, is assigned are taken into account for the further evaluation. The volume of data to be examined can be significantly reduced by this measure, as a result of which the method overall can be performed faster.

Next, a plausibility check is performed on the previously filtered measurement data. This is checked to determine whether they are in any way relevant to a pressure sensor. In particular, a temporal dependence of the measurement data is considered in this case. However, statistical values such as means, medians, variances, offsets and the like may also be used within the scope of the plausibility check.

If the measurement data of a particular measurement point is constant over a time period in which there are changes in a position of the valve and the flow through the valve, then the examined measurement data cannot relate to a valve output pressure.

The measurement data deemed implausible that has been obtained from particular measurement points is then no longer taken into account for the further evaluation.

The measurement data for the valve position and the flow is assigned to the valve asset, but the measurement data of the pressure upstream and downstream of the valve has not yet been assigned. All the measurement data is in a physical relationship and can be brought into a relationship via an equation stored in the cloud. Unknown parameters of the equation can be estimated with the aid of the measurement data transferred to the cloud using conventional methods, such as the method of least squares. In the process, all measurement data that may still be relevant is permutated through by pressure signals and a parameter set is learned for all combinations.

The estimation using measurement data originating from measurement points assigned to the valve asset leads in this case to a comparatively small deviation of the estimated equation from the measurement data, in other words to a small residual. Conversely, the estimation using measurement data that is not assigned to the particular asset leads to a large deviation or to a large residual. The estimation can in this case be performed sequentially for the respective measurement data obtained from a measurement point or, given a correspondingly present calculation architecture, also in parallel.

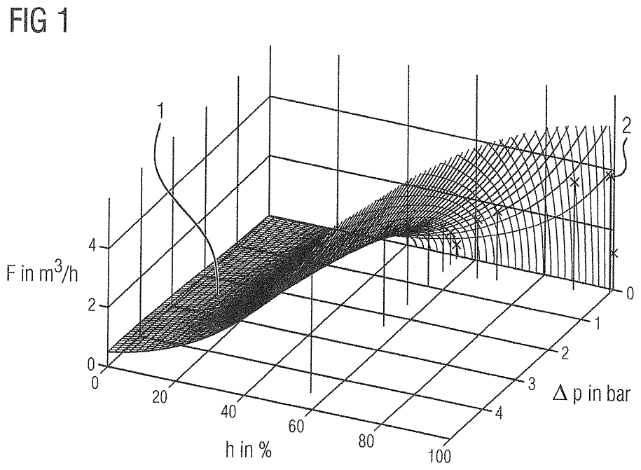

FIG. 1 shows a graphical plot of a characteristic map 1 of the valve. This charts the dependence between the flow (in cubic meters per hour), the valve opening (in percent) and the pressure difference upstream and downstream of the valve (in bar). Individual data points 2 of the measurement data from a pressure sensor that are to be assigned are shown in addition. It can clearly be seen that the deviation of the data points from the (setpoint) characteristic map is very small, i.e., the data points, in other words, fit very well into the characteristic map.

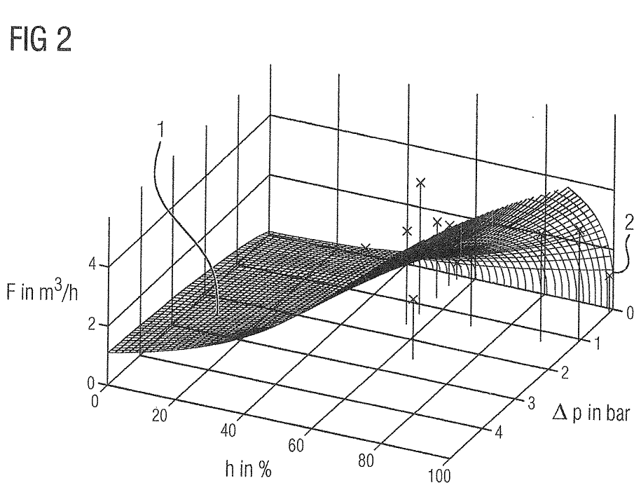

The inverse case is shown in FIG. 2. The data points 2 are a very poor fit to the characteristic map 1, i.e., the deviation is very great. It may therefore be assumed that the measurement point associated with the examined measurement data does not belong to the valve asset.

At the end of the method, the valve position, the flow and the pressure upstream and downstream of the valve are known for the valve.

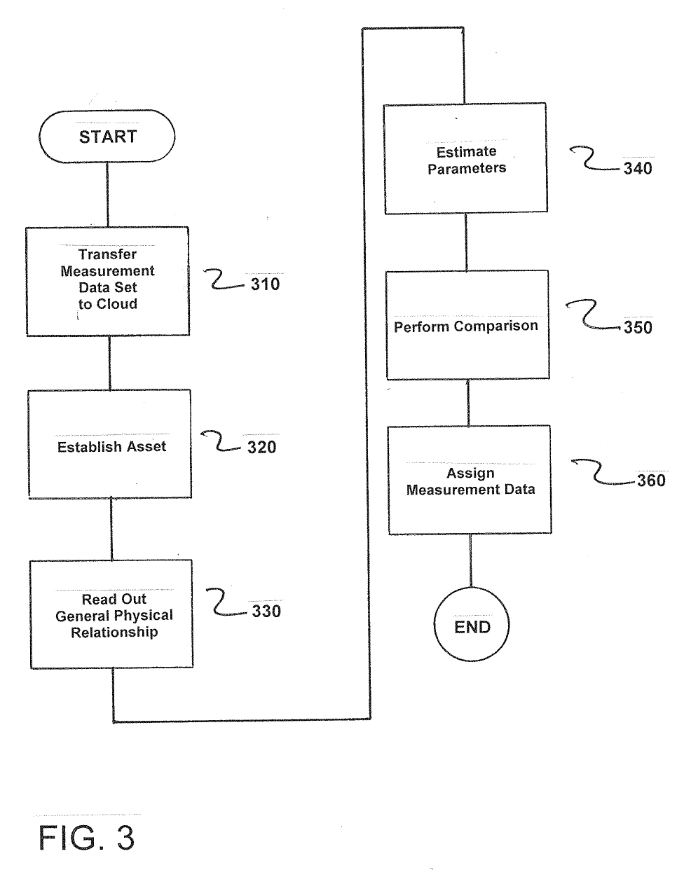

FIG. 3 is a flowchart of the method for assigning measurement data for cloud-based monitoring of mechanical assets of an industrial facility including a measurement data archive in which measurement data from a plurality of measurement points is stored.

The method comprises transferring a subset or a total set of the measurement data from the measurement data archive to a cloud to enable further processing of the measurement data in the cloud, as indicated in step 310.

Next, an asset which has a particular type is established, as indicated in step 320. In accordance with the invention, the asset being assigned a characteristic measurement value with an associated measurement point in the cloud.

Next, a general physical relationship, stored in the cloud for the particular asset type, between measurement values, relevant to the particular asset type, obtained from different measurement points is read out, as indicated in step 330. Here, the general physical relationship have a number of parameters that are to be determined.

Next, estimating the parameters of the physical relationship are estimated step-by-step utilizing the characteristic measurement value belonging to the particular asset type and the measurement data, stored in the measurement data archive, of the measurement values relevant to the particular asset, as indicated in step 340.

A previously determined physical relationship is now compared step-by-step with the measurement data utilized for the estimation and a residual is determined, as indicated in step 350.

Next, a the measurement data is assigned to a particular asset based on a statistical evaluation of the determined residual, as indicated in step 360.

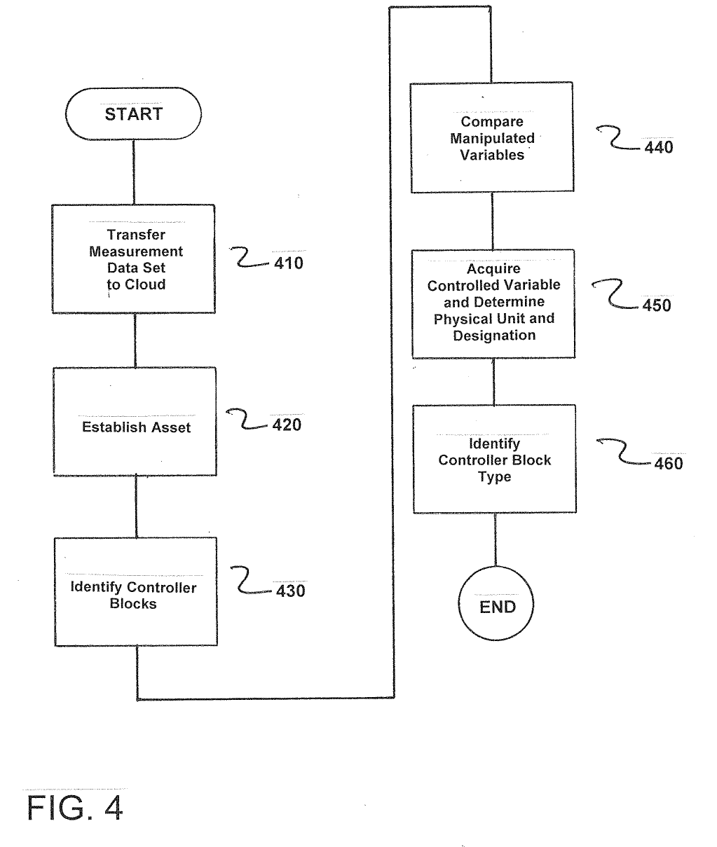

FIG. 4 is a flowchart of the method for assigning measurement data for cloud-based monitoring of mechanical assets of an industrial facility including a measurement data archive in which measurement data from a plurality of measurement points is stored in accordance with an alternative embodiment.

The method comprises transferring a subset or a total set of the measurement data from the measurement data archive to a cloud to enable further processing of the measurement data in the cloud, as indicated in step 410.

Next, an asset which has a particular type is established, as indicated in step 420. In accordance with the invention, the asset is assigned a characteristic measurement value with an associated measurement point in the cloud.

Next, controller blocks that form part of the industrial facility are identified, as indicated in step 430.

Next, all manipulated variables of the identified controller blocks are compared with setpoints stored in the either (i) the measurement data archive mechanical assets and/or (ii) the cloud for mechanical assets, as indicated in step 440.

A controlled variable of a respective controller block is now acquired and determining a physical unit and a designation for an associated measurement point of the controlled variable are determined, as indicated in step 450.

Next, a type of the respective controller block is identified based on the controlled variable and its physical unit and measurement point designation, as indicated in step 460.

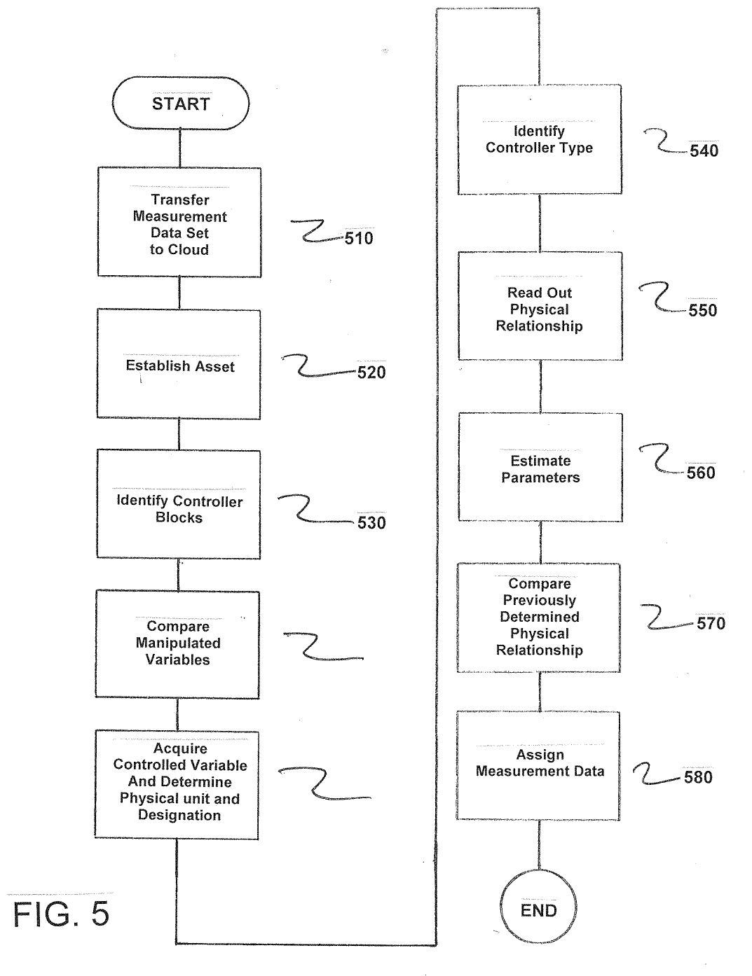

FIG. 5 is a flowchart of the method for assigning measurement data for cloud-based monitoring of mechanical assets of an industrial facility including a measurement data archive in which measurement data from a plurality of measurement points is stored in accordance with a further embodiment.

The method comprises transferring a subset or a total set of the measurement data from the measurement data archive to a cloud to enable further processing of the measurement data in the cloud, as indicated in step 510.

Next, an asset that has a particular type is established, as indicated in step 520. In accordance with the invention, the asset is assigned a characteristic measurement value with an associated measurement point in the cloud.

Next, controller blocks that form part of the industrial facility are identified, as indicated in step 530.

Next, all manipulated variables of the identified controller blocks are compared with setpoints stored in the either (i) the measurement data archive for mechanical assets and/or (ii) the cloud for mechanical assets, as indicated in step 540.

Next, a controlled variable of a respective controller block is acquired and a physical unit and a designation for an associated measurement point of the controlled variable are determined, as indicated in step 550.

Next, a type of the respective controller block is identified based on the controlled variable and its physical unit and measurement point designation, as indicated in step 560.

Next, a general physical relationship, stored in the cloud for the particular asset type, between measurement values, relevant to the particular asset type, obtained from different measurement points is read out, as indicated in step 570.

Next, parameters of the physical relationship are estimated step-by-step utilizing the characteristic measurement value belonging to the particular asset type and the measurement data, stored in the measurement data archive, of the measurement values relevant to the particular asset, as indicated in step 580.

Next, the previously determined physical relationship is compared step-by-step with the measurement data used for the estimation and a residual is determined, as indicated in step 590.

The measurement data is now assigned to a particular asset based on a statistical evaluation of the determined residual, as indicated in step 595.

Although the invention has been illustrated and described in more detail on the basis of the preferred exemplary embodiment, the invention is not limited by the disclosed examples and other variations may be derived herefrom by the person skilled in the art without leaving the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for assigning measurement data for cloud-based monitoring of mechanical assets of an industrial facility including a measurement data archive in which measurement data from a plurality of measurement points is stored, the method comprising:
a) transferring a subset or a total set of the measurement data from the measurement data archive to a cloud to enable further processing of the measurement data in the cloud;
b) establishing an asset which has a particular type, the asset being assigned a characteristic measurement value with an associated measurement point in the cloud;
c) reading out a general physical relationship, stored in the cloud for the particular asset type, between measurement values, relevant to the particular asset type, obtained from different measurement points, the general physical relationship having a number of parameters that are to be determined;
d) estimating the parameters of the physical relationship step-by-step utilizing the characteristic measurement value belonging to the particular asset type and the measurement data, stored in the measurement data archive, of the measurement values relevant to the particular asset;
e) comparing a previously determined physical relationship step-by-step with the measurement data utilized for said estimation and determining a residual; and
f) assigning the measurement data to a particular asset based on a statistical evaluation of the determined residual.

16. The method as claimed in claim 15, wherein prior to performing method steps d) to f), measurement data to which a particular physical unit is assigned is identified in the cloud to exclude measurement data which is irrelevant to the physical relationship which is relevant to the particular asset type from the further evaluation.

17. The method as claimed in claim 15, wherein prior to performing method steps d) to f), the measurement data transferred to the cloud is subjected to a plausibility check such that characteristic features of the measurement data are brought into a relationship with the particular asset to take no further account of implausible measurement data for the further assignment method.

18. The method as claimed in claim 16, wherein prior to performing method steps d) to f), the measurement data transferred to the cloud is subjected to a plausibility check such that characteristic features of the measurement data are brought into a relationship with the particular asset to take no further account of implausible measurement data for the further assignment method.

19. The method as claimed in claim 15, wherein the particular type comprises a valve or a pump.

20. The method as claimed in claim 15, wherein the plurality of measurement points are located at pressure or flow sensors.

21. The method as claimed in claim 17, wherein the characteristic features of the measurement data comprise a variation with time of the measurement data.

22. The method as claimed in claim 20, wherein the characteristic features of the measurement data comprise a variation with time of the measurement data.

23. A method for assigning measurement data for cloud-based monitoring of mechanical assets of an industrial facility including a measurement data archive in which measurement data from a plurality of measurement points is stored, the method comprising:
a) transferring a subset or a total set of the measurement data from the measurement data archive to a cloud to enable further processing of the measurement data in the cloud;
b) establishing an asset which has a particular type, the asset being assigned a characteristic measurement value with an associated measurement point in the cloud;
c) identifying controller blocks which form part of the industrial facility;
d) comparing all manipulated variables of the identified controller blocks with setpoints stored in the at least one of (i) the measurement data archive mechanical assets and (ii) the cloud for mechanical assets;
e) acquiring a controlled variable of a respective controller block and determining a physical unit and a designation for an associated measurement point of the controlled variable; and
f) identifying a type of the respective controller block based on the controlled variable and its physical unit and measurement point designation.

24. The method as claimed in claim 23, wherein the plurality of measurement points are located at pressure or flow sensors.

25. The method as claimed in claim 23, wherein the particular type comprises a valve or a pump.

26. A method for assigning measurement data for cloud-based monitoring of mechanical assets of an industrial facility including a measurement data archive in which measurement data from a plurality of measurement points is stored, the method comprising:
a) transferring a subset or a total set of the measurement data from the measurement data archive to a cloud to enable further processing of the measurement data in the cloud;
b) establishing an asset which has a particular type, the asset being assigned a characteristic measurement value with an associated measurement point in the cloud;
c) identifying controller blocks which form part of the industrial facility;
d) comparing all manipulated variables of the identified controller blocks with setpoints stored in the at least one of (i) the measurement data archive for mechanical assets and (ii) the cloud for mechanical assets;
e) acquiring a controlled variable of a respective controller block and determining a physical unit and a designation for an associated measurement point of the controlled variable;
f) identifying a type of the respective controller block based on the controlled variable and its physical unit and measurement point designation;
g) reading out a general physical relationship, stored in the cloud for the particular asset type, between measurement values, relevant to the particular asset type, obtained from different measurement points;
h) estimating parameters of the physical relationship step-by-step utilizing the characteristic measurement value belonging to the particular asset type and the measurement data, stored in the measurement data archive, of the measurement values relevant to the particular asset;
i) comparing the previously determined physical relationship step-by-step with the measurement data used for the estimation and determining a residual; and
j) assigning the measurement data to a particular asset based on a statistical i) evaluation of the determined residual.

27. The method as claimed in claim 26, wherein prior to performing method steps h) to j), measurement data to which a particular physical unit is assigned is identified in the cloud to exclude measurement data which is irrelevant to the physical relationship which is relevant to the particular asset type from the further evaluation.

28. The method as claimed in claim 26, wherein prior to performing method steps h) to j), measurement data transferred to the cloud is subjected to a plausibility check such that characteristic features of the measurement data are brought into a relationship with the particular asset to take no further account of implausible measurement data for the further assignment method.

29. The method as claimed in claim 27, wherein prior to performing method steps h) to j), measurement data transferred to the cloud is subjected to a plausibility check such that characteristic features of the measurement data are brought into a relationship with the particular asset to take no further account of implausible measurement data for the further assignment method.

30. The method as claimed in claim 26, wherein only a subsection of the industrial facility is taken into account for assigning the measurement data.

31. The method as claimed in claim 26, wherein the measurement data is subdivided into training data and validation data prior to commencement of the assignment method.

32. The method as claimed in claim 26, wherein subsequent to completion of the assignment method, a user of the industrial facility is automatically presented with suggestions relating to an assignment of individual measurement data to particular assets.

33. The method as claimed in claim 32, wherein subsequent to completion of the assignment method, the user is automatically presented with a multiplicity of suggestions, whereupon the user can make a manual decision about a definitive assignment of the measurement data to particular assets.

34. The method as claimed in claim 26, wherein the plurality of measurement points are located at pressure or flow sensors.

35. The method as claimed in claim 26, wherein the particular type comprises a valve or a pump.

36. The method as claimed in claim 28, wherein the characteristic features of the measurement data comprise a variation with time of the measurement data.

37. The method as claimed in claim 29, wherein the characteristic features of the measurement data comprise a variation with time of the measurement data.

38. The method as claimed in claim 26, wherein the a subsection of the industrial facility comprises a process engineering unit.

39. A computer program having computer-executable program code instructions for implementing the method as claimed in claim 15.

40. A non-transitory computer-readable medium having the computer-executable computer program as claimed in claim 39.

41. A computer system upon which a computer program as claimed in claim 39 is implemented.
